(19) United States
(12) Patent Application Publication
(10) Pub. No.: US 2013/0343089 A1
(43) Pub. Date: Dec. 26, 2013

(54) SCALABLE-VOLTAGE CURRENT-LINK POWER ELECTRONIC SYSTEM FOR MULTI-PHASE AC OR DC LOADS

(71) Applicants: Ranjan Kumar Gupta, Schenectady, NY (US); Ravisekhar Nadimpalli Raju, Clifton Park, NY (US); Rajib Datta, Niskayuna, NY (US); Mohammed Agamy, Niskayuna, NY (US)

(72) Inventors: Ranjan Kumar Gupta, Schenectady, NY (US); Ravisekhar Nadimpalli Raju, Clifton Park, NY (US); Rajib Datta, Niskayuna, NY (US); Mohammed Agamy, Niskayuna, NY (US)

(73) Assignee: GENERAL ELECTRIC COMPANY, SCHENECTADY, NY (US)

(21) Appl. No.: 13/531,629

(22) Filed: Jun. 25, 2012

(51) Int. Cl. H02M 3/335

(52) U.S. Cl. 363/16

(57) ABSTRACT

An electronics power system includes a plurality of substantially identical power electronic modules. Each power electronic module includes a single-phase DC/AC inverter having an output side. Each power electronic module further includes a medium/high-frequency-isolated DC/DC current-to-voltage converter having an input side. The medium/high-frequency-isolated DC/DC current-to-voltage converter drives the single-phase DC/AC inverter. Each DC/DC converter and its corresponding DC/AC inverter are connected back-to-back sharing a common DC-link. The plurality of power electronics modules is stacked together in series at the input side and in parallel or series/parallel at the output side.

### BACKGROUND

The subject matter of this disclosure relates generally to power electronic systems, and more particularly to a scalable-voltage current-link power electronic system suitable for use in high-voltage mega-watt drives located at the offshore platform for oil and gas, current-link based high voltage DC (HVDC) taps, mega-watt drives for subsea oil and gas, and HVDC transmission and distribution (HVTD).

The distance between the source (three-phase 60 Hz grid) and the load (e.g. many compressor drives, each P>10 MW) may be more than 100 km for an exemplary current-link system. Three-phase grid voltage at the source side is actively rectified and converted to a constant current source. Current source inverters (CSI) at the load side may be used to generate three-phase voltage at the load terminals. Hence, the power is supplied through a current-link based DC transmission system which is similar to the HVDC-classic. The value of the current source is limited by two factors: 1) transmission line rated current capability and 2) transmission line losses. A typical value for multi mega-watt transmission and distribution system is 400 A.

One example of a three-phase compressor drive 10 using state-of-the-art technology for the current-fed system described above is illustrated in FIG. 1. The DC current source 12 is a converted into a constant DC voltage source using a three-level DC-DC current-to-voltage converter 14. A three-level DC/AC inverter 16 connected back-to-back with the converter 14 then generates three-phase voltage of desired magnitude and frequency at the machine terminals.

Due to the limitation on the blocking voltage of the Si devices (e.g. IGCTs up to 6.6 kV) the DC-link voltage is limited to 5.4 kV. To supply 12 MW power to the compressor, the reflected DC voltage at the input of the drive system (assuming 400 A current source) is required to be at least 30 kV. Hence, six 5.4 kV drive modules as shown in FIG. 1 are required. They are connected in series at the input terminals (current source side). The outputs of the modules are connected in series/parallel with the help of low-frequency transformers 18. The transformers are required to combine the output voltages of each 5.4 kV modules, and to maintain the machine isolation voltage at a low value.

The state-of-the-art system depicted in FIG. 1 is disadvantageous in that the switching frequency (typically 400-600 Hz) of 5.5 kV devices is limited due to thermal management requirements. Hence, it causes the following: a) low band-width of the control loops, b) application of selective harmonic elimination (SHM); due to low PWM frequency, space vector PWM is not possible, and c) poor input-output waveforms.

Further, six low frequency transformers 18 are required to provide isolation and to combine the output voltages from each 5.4 kV drive module. Due to the presence of transformers 18, there are significant challenges in generating very low frequency three-phase output voltage. The DC output generation is not possible which is often required to start a three-phase PMAC.

Scalability of the state-of-the-art technology is possible to drive a machine with a higher voltage rating. However, at the cost of the increase in the number of low-frequency transformers described above, this may not be feasible if power density is the premium requirement e.g. for the subsea oil and gas applications.

Therefore, what is needed is a scalable-voltage current-fed power electronic system for multi-phase AC or DC loads that avoids the drawbacks of state-of-the-art technology for current-fed power electronics systems.

### BRIEF DESCRIPTION

One aspect of the present disclosure is directed to an electronics power system comprising a plurality of substantially identical power electronic modules. Each power electronic module comprises a medium/high-frequency-isolated DC/DC current-to-voltage converter driving a single-phase DC/AC inverter. Each DC/DC converter and its corresponding DC/AC inverter are connected back-to-back sharing a common DC-link. The plurality of power electronics modules is stacked together in series at the input side and in parallel or series/parallel at the output side.

Another aspect of the present disclosure is directed to an electronics power system comprising a plurality of substantially identical power electronic modules. Each power electronics module comprises a medium/high-frequency-transformer isolated current-to-voltage converter driving a single-phase DC/AC inverter. The plurality of substantially identical power electronic modules is stacked together in series at the input side and in parallel or series/parallel at the output side to provide a scalable output voltage.

According to yet another aspect of the present disclosure, an electronics power system comprises a plurality of substantially identical power electronic modules. Each power electronics module comprises a medium/high-frequency-isolated soft switching resonant based DC/DC current-to-voltage converter driving a DC/AC inverter. Each DC/DC converter and its corresponding DC/AC inverter are connected back-to-back sharing a common DC-link. The plurality of power electronic modules is stacked together in series at the input side and in parallel or series/parallel at the output side.

According to one more aspect of the present disclosure, an electronics power system comprises a plurality of substantially identical power electronic modules. Each power electronics module comprises a medium/high-frequency-isolated soft switching resonant based DC/DC current-to-voltage folder-converter driving a DC/AC un-folder inverter. The DC/DC current-to-voltage folder-converter converts a constant DC current to a two-pulse or multi-pulse DC voltage which is unfolded to a sine wave ac voltage by the DC/AC un-folder inverter. Each DC/DC folder-converter and its corresponding DC/AC un-folder inverter are connected back-to-back sharing a common pulsating DC-link. The plurality of power electronic modules is stacked together in series at the input side and in parallel or series/parallel at the output side.

According to one more aspect of the present disclosure, an electronics power system comprises a plurality of substantially identical power electronic modules. Each power electronics module comprises plurality of a medium/high-frequency-isolated soft switching resonant based DC/DC current-to-voltage folder-converter driving a DC/AC un-folder inverter. A plurality of DC/DC current-to-voltage folder-converters, controlled in interleaved fashion, converts a constant DC current to a fixed DC voltage (requiring a very small snubber capacitor in the dc-link), driving a DC/AC inverter. A plurality of power electronics modules comprising a plurality of DC/DC converters and corresponding DC/AC inverters are connected back-to-back sharing a common DC-link (requiring very small snubber capacitor). The plurality of power electronic modules is stacked together in series at the input side and in parallel or series/parallel at the output side.

These and other features, aspects and advantages of the present embodiments will become better understood with reference to the following description and appended claims. The accompanying drawings, which are incorporated in and con-stitute a part of this specification, illustrate embodiments of the invention and, together with the description, serve to explain the principles of the invention.

### DRAWINGS

The foregoing and other features, aspects and advantages of the invention are apparent from the following detailed description taken in conjunction with the accompanying drawings in which like characters represent like parts throughout the drawings, wherein:

FIG. 1 illustrates an exemplary multi mega-watt drive using state-of-the-art technology;

FIG. 2 illustrates a modular three-phase drive according to one embodiment;

FIG. 3 illustrates a modular 6.6 kV, 12 MW drive according to one embodiment;

FIG. 4 is a simplified schematic illustrating a power electronic module according to one embodiment;

FIG. 5 illustrates a modular power electronic module with a resonant tank circuit according to one embodiment;

FIG. 6 illustrates a modular power electronic module with a resonant tank circuit according to another embodiment;

FIG. 7 illustrates a modular power electronic module with a resonant tank circuit according to yet another embodiment;

FIG. 8 illustrates a 1 MW, 3-cell stack power electronic system according to one embodiment where a plurality of DC/DC converters are interleaved to form a DC voltage link with a very small snubber capacitor;

FIG. 9 illustrates a plurality of modular power electronic modules configured to distribute multi-phase AC/DC loads according to one embodiment;

FIG. 10 illustrates a scalable-voltage power electronic system using a plurality of modular power electronic modules according to one embodiment; and

FIG. 11 illustrates a current-link based HVDC power transmission and distribution system using a plurality of modular power electronic modules according to one embodiment;

FIG. 12 illustrates a current-link based HVDC power transmission and distribution system, for bidirectional power flow, using a plurality of modular power electronic modules according to one embodiment; and

FIG. 13 illustrates a current-link based drive system using a plurality of power electronics modules containing a DC/DC folder-converter followed by DC/AC un-folder inverter according to one embodiment.

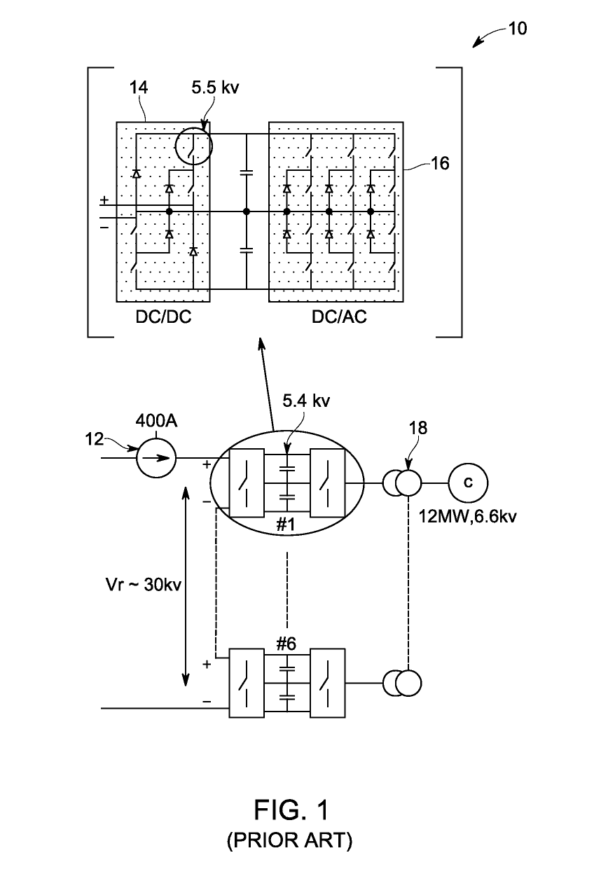

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

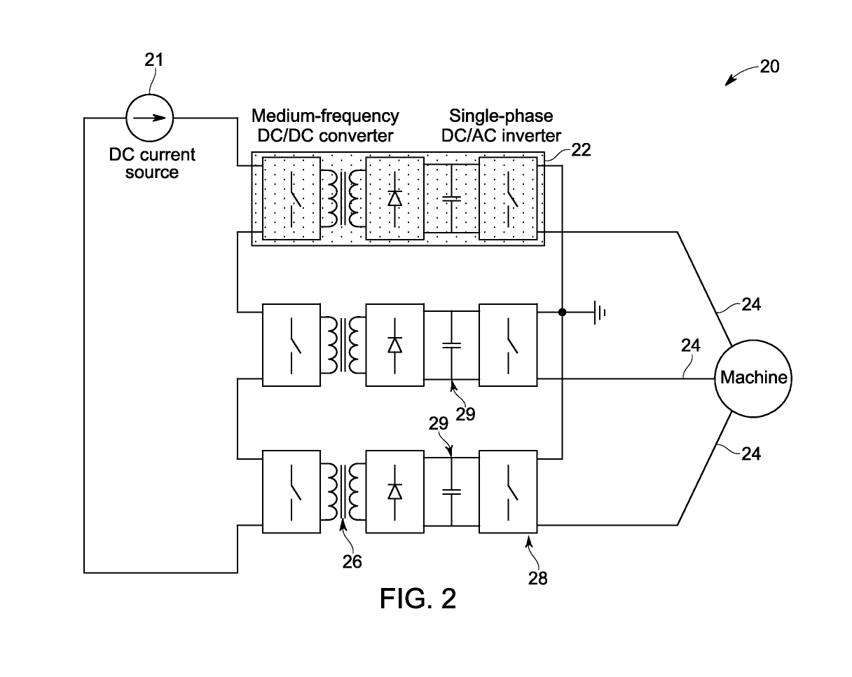

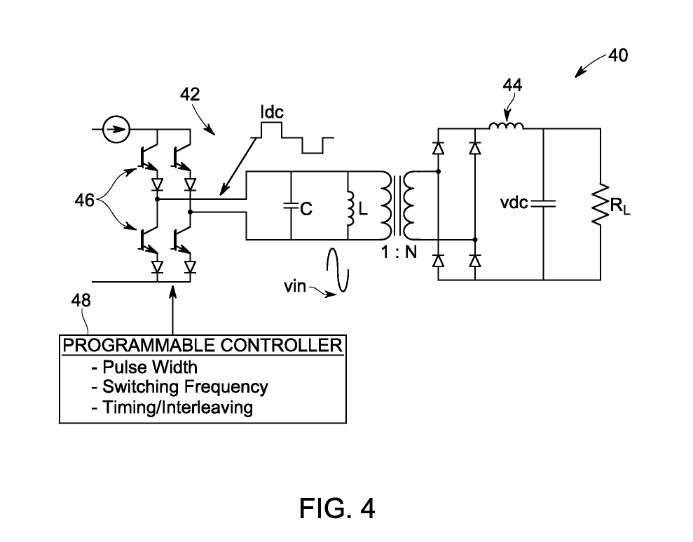

Referring to FIG. 2, an exemplary multi mega-watt modular three-phase drive system 20 is illustrated using state-of-the-art technology. Identical power electronic modules 22 are used to generate AC voltage at the machine terminals 24. However, as described herein, n-phase DC or AC output can be generated using plurality of modules 22. A module 22 comprises a medium/high-frequency-isolated DC/DC current-to-voltage converter 26 and a single-phase DC/AC converter 28. The DC/DC and DC/AC converters 26, 28 are connected back-to-back sharing the same dc-link 29. A more detailed description of DC/DC converter 26 and DC/AC converter 28 are presented herein with reference to FIGS. 4-11.

Those skilled in the transformer art will appreciate that a higher excitation frequency of a transformer will allow a reduction in its size and weight for a particular application. Hence, each module 22 is expected to have high power density. With continued reference to FIG. 2, one module 22 per output phase is used. However, as stated herein, many modules per-phase can be used which is suitable for a mega-watt drive where multi-level voltage at the machine terminals is desirable.

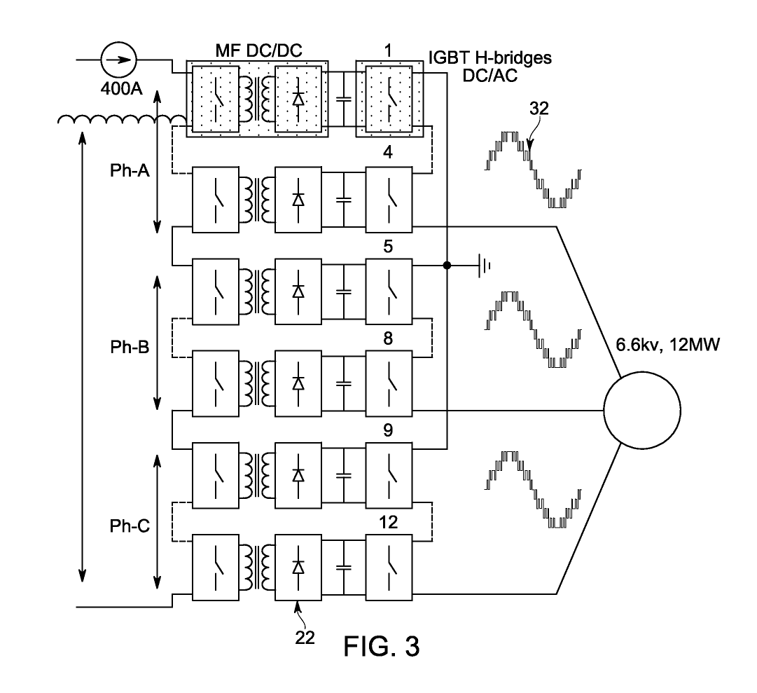

FIG. 3 illustrates a modular 6.6 kV, 12 MW drive system 30 for a 400 A DC current source. Drive system 30 uses four modules 22 per phase. The output phase voltage 32 has 9 levels. The modular nature of drive system 30 allows the use of many modules per phase to advantageously provide for a scalable output voltage. Further, the modules 22 can advantageously be interleaved (both at the input and output) to generate high quality input-output waveforms.

FIG. 4 is a schematic illustrating a more detailed view of a power electronic module 40 suitable for use with drive system 20 according to one embodiment. Power electronic module 40 comprises a dc/dc converter stage 42 followed by a single phase dc/ac inverter stage 44. The module 40 shown in FIG. 4 is simplified for purposes of discussion by depicting the dc/ac inverter stage 44 as a resistor load R_{L}. The current-to-voltage conversion is achieved by a soft switching resonant based dc/dc converter 42, according to one embodiment. The current fed parallel resonant converter 42 shown in FIG. 4 can be considered as the dual of the conventional voltage fed series resonant converter. This resonant converter 42 provides a relatively flat efficiency curve versus load; and with proper tuning of the switching frequency, it can provide soft switching for the bridge devices 46. Further, more control flexibility can be provided through the use of multiple control variables (pulse width and frequency).

With continued reference to FIG. 4, a programmable controller 48 is employed to control without limitation, switching frequencies, pulse widths, and frequency modulations i.e. timing and interleaving. More specifically, programmable controller 48 may control switching frequencies associated with the bridge devices 46. Pulse widths generated by the bridge devices 46 may also be controlled via programmable controller 48. Further, a plurality of modules 22, 42 can advantageously be interleaved (both at the input and output) to generate high quality input-output waveforms, as stated herein.

The use of a combination of pulse width and frequency modulations to regulate the output voltage for different load values helps reduce the range of variation of both variables, thus avoiding the application of very narrow pulse widths at light load conditions, which can help maintain the soft switching operation over a wider load range as compared to using a fixed frequency approach. The range of frequency variation is also narrow (1-1.5 times the resonant frequency), which does not complicate filter designs.

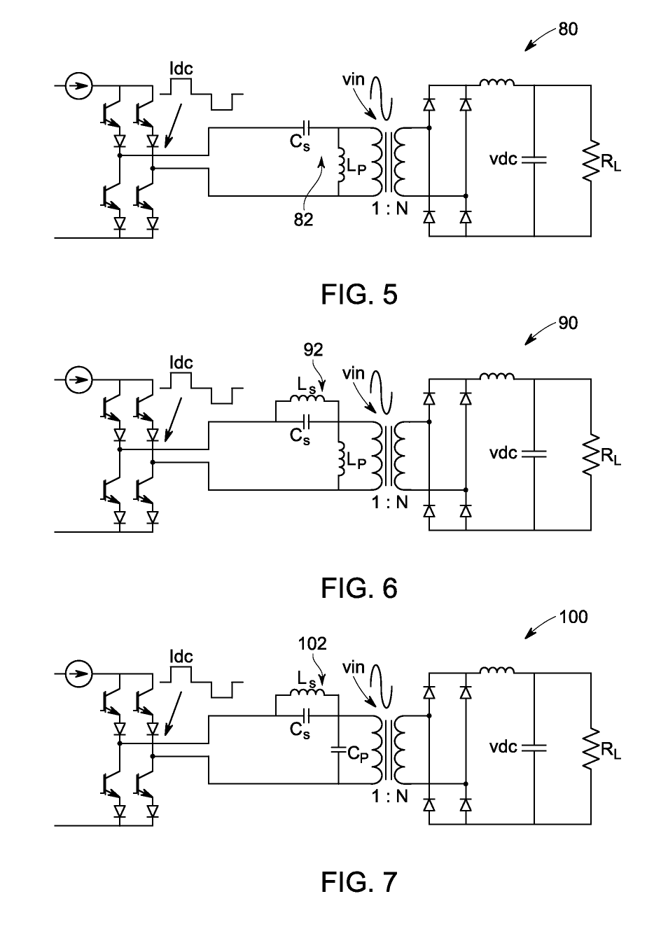

Numerous resonant topology variants such as, but not limited to, those shown in FIGS. 5-7 can also be used in accordance with the principles described herein to provide different dynamic characteristics and voltage/current regulation capabilities. FIG. 5 illustrates another modular power electronic module 80 with a resonant tank circuit 82 according to one embodiment. FIG. 6 illustrates a modular power electronic module 90 with a resonant tank circuit 92 according to another embodiment. FIG. 7 illustrates a modular power electronic module 100 with a resonant tank circuit 102 according to yet another embodiment

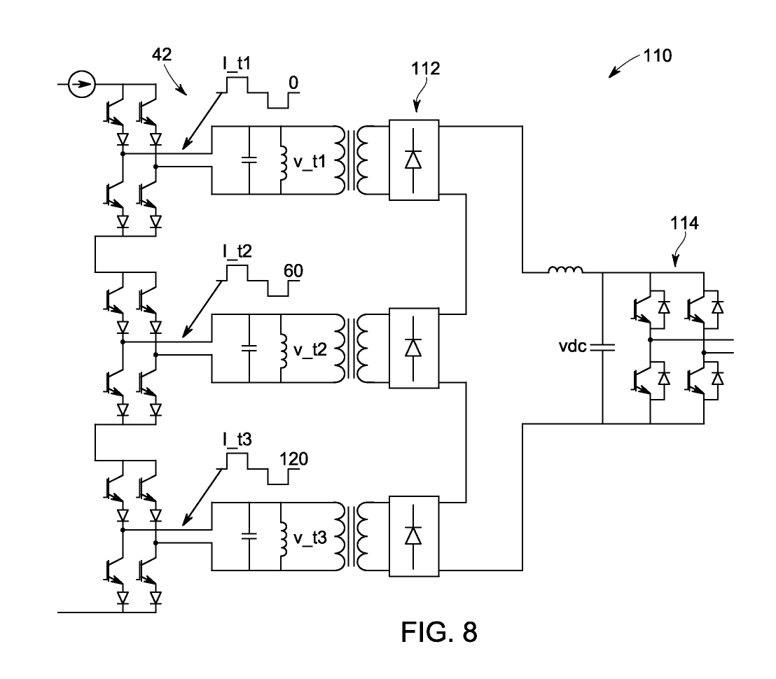

A flexible modular approach can be used to stack the converters such that the outputs of the rectifier stage 112 are connected in series for high voltage applications, such as illustrated in FIG. 8. Furthermore, applying a phase shift between the currents of each converter provides a lower output ripple and thus smaller dc link filter requirements. FIG. 8 shows an exemplary 1 MW, 3-cell stack power electronic system 110 according to one embodiment. The resistor load R_{L} is now replaced by a dc/ac inverter (H-bridge) stage 114.

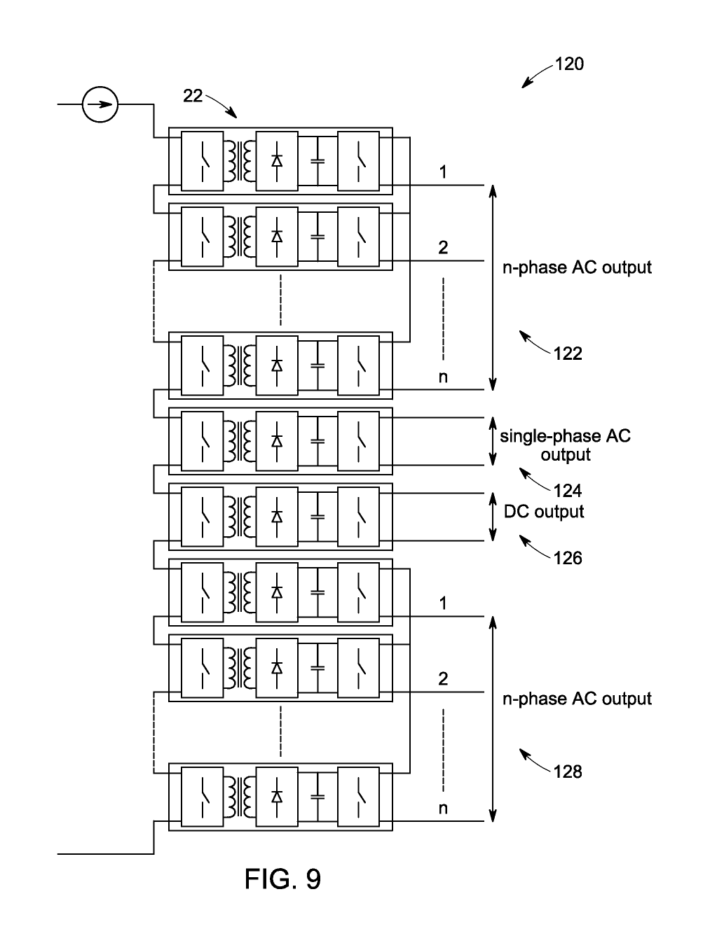

FIG. 9 illustrates a plurality of modular power electronic modules 22 configured to distribute multi-phase AC/DC loads 120 according to one embodiment. The distribution system 120 may comprise of n-phase AC loads 122, 124, 128 and DC loads 126 operating at various voltage levels. Each power electronic module 22 can generate single-phase ac/dc voltage waveforms. Hence, by connecting a plurality of modules in series at the input side, as shown in FIG. 9, n-phase output waveforms can be generated. It can be observed from FIG. 9 that a variety of single-phase, n-phase ac or dc loads can be driven by simply connecting many modules 22 in series at the input

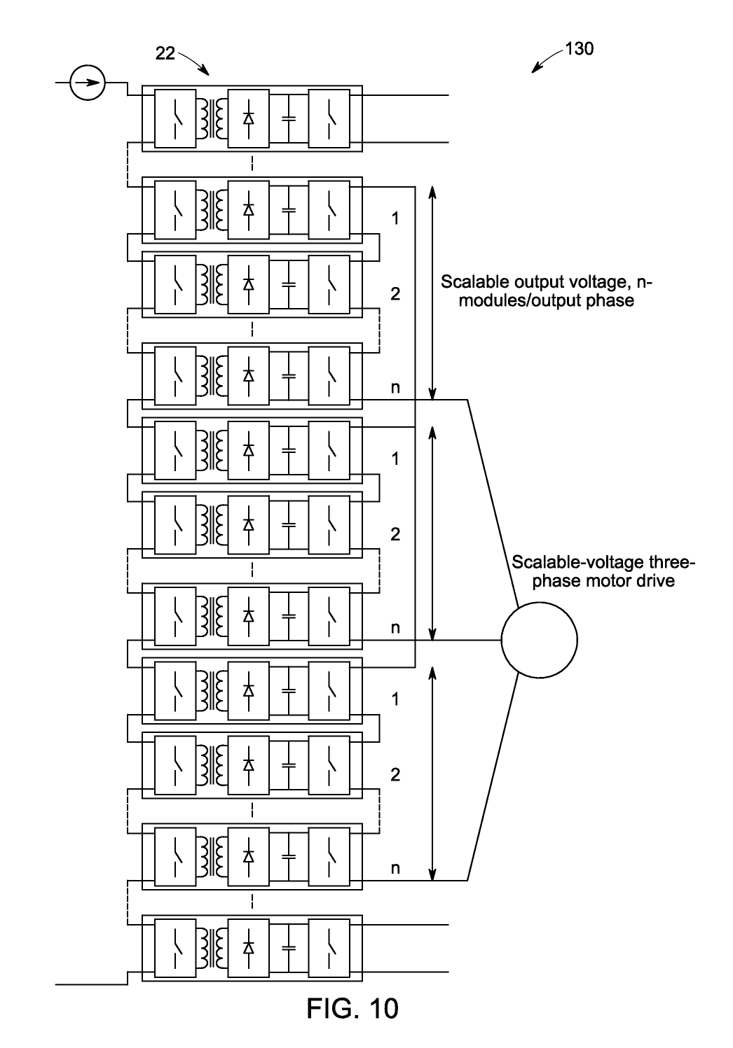

The principles described herein can be extended to per-phase applications. If it can be assumed for example, the magnitude of output voltage from each module is 1 per-unit (p.u.), and since the output terminals are isolated (provided by the medium/high frequency transformer used in the resonant circuit topology depicted in FIG. 4, the output of n modules 40 can be connected in series to generate n per-unit voltage per output phase as shown in FIG. 10. FIG. 10 illustrates a scalable-voltage power electronic system 130 using a plurality of modular power electronic modules 22 according to one embodiment.

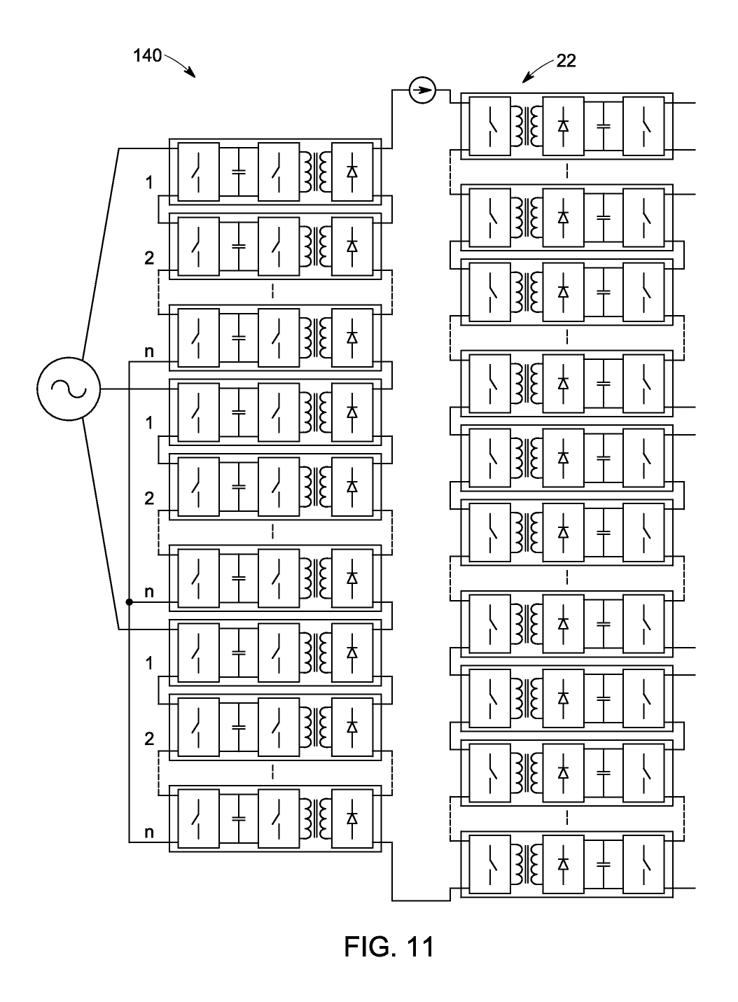

With continued reference now to FIG. 2, the input to the embodied system 20 is a dc current source 21. The outputs are n-phase voltage waveforms of adjustable magnitude and frequency. However, following the principle of duality, the input to the system 20 can be an n-phase voltage source and the output can be a constant dc-current load. A dual power electronic topology is used at the grid side (sending end), as shown in FIG. 11, to convert the three-phase 60 Hz grid voltage to a constant dc-current. Once conversion to dc-current is achieved, the principles described herein are applied to drive multi-phase ad dc loads at the receiving end of a high voltage DC (HVDC) power transmission and distribution (T/D) system. FIG. 11 illustrates a current-link based HVDC power transmission and distribution system 140 using a plurality of modular power electronic modules 22 according to one embodiment.

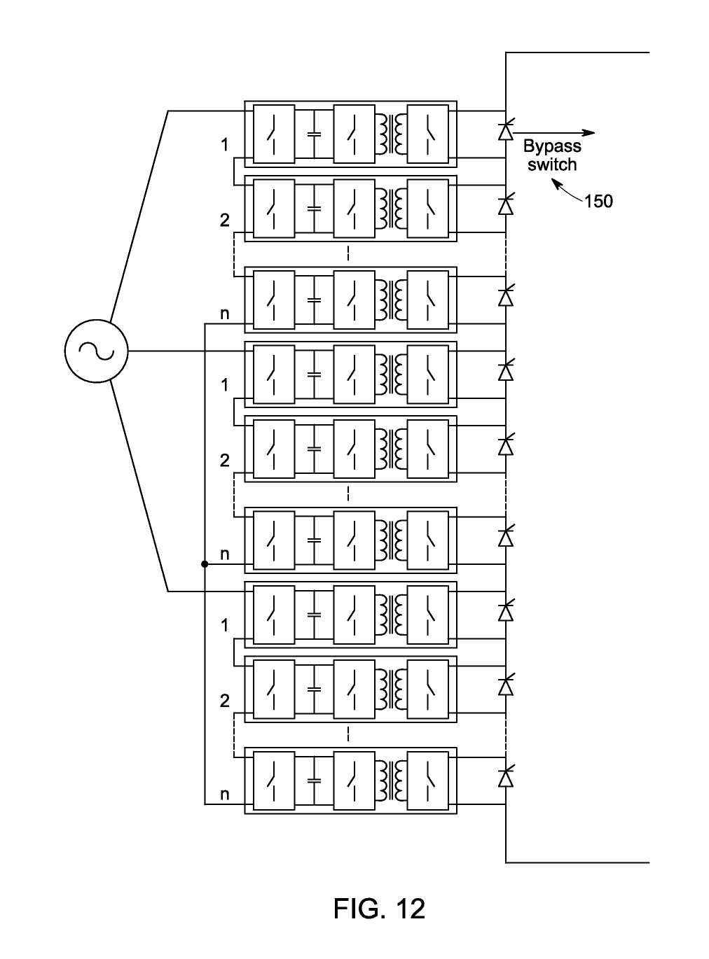

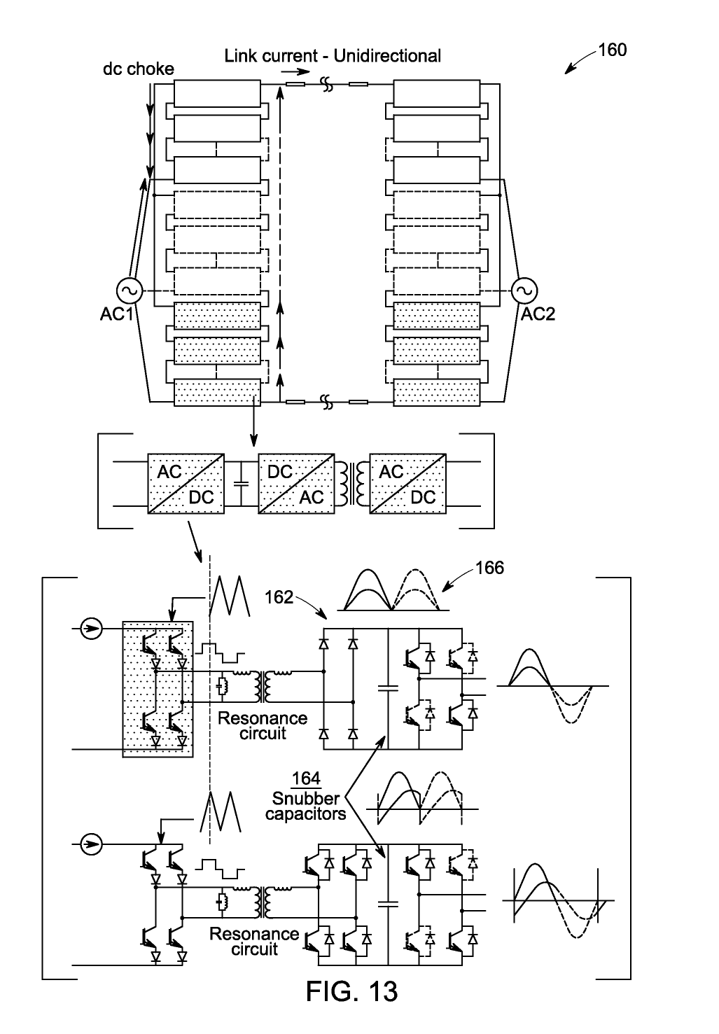

The series connected modular structure of the power electronic modules provides the capability of bypassing any faulted module with a fast bypass switch 150, as shown in FIG. 12 while the remaining modules stay operational, hence increasing the system reliability and availability according to one embodiment.

In a HVDC transmission application where pluralities of modules are connected in series as shown in FIG. 12, the overall DC transmission voltage can be controlled by engaging or bypassing modules while each module operating at a fixed loading condition.

In another embodiment, as illustrated in FIG. 13, the plurality of power electronic modules, each containing a DC/DC current-to-voltage folder/un-folder converter connected back-to-back to a AC/DC or DC/AC folder/un-folder converter, are configured to realize a high voltage AC/DC or DC/AC power conversion system 160. The rectifier/inverter 162 advantageously requires only a small snubber capacitor 164 such that the dc-link voltage 166 is a rectified sinusoidal waveform. It should be noted that a snubber capacitor is not used to account for unbalance energy such as generally associated with a dc-link capacitor that typically stores instantaneous unbalance energy between a DC/DC converter and a DC/AC converter. A snubber capacitor is small compared to a dc-link capacitor since it is used to protect devices from switching overvoltage instead of unbalance energy.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electronics power system comprising:
a plurality of substantially identical power electronic modules, wherein each power electronic module comprises:
a single-phase DC/AC inverter comprising an output side; and
a medium/high-frequency-isolated DC/DC current-to-voltage converter comprising an input side, the medium/high-frequency-isolated DC/DC current-to-voltage converter driving the single-phase DC/AC inverter, wherein each DC/DC converter and its corresponding DC/AC inverter are connected back-to-back sharing a common DC-link, and further wherein the plurality of power electronics modules is stacked together in series at the input side and in parallel or series/parallel at the output side.

2. The electronics power system according to claim 1, further comprising a DC current source feeding the input side.

3. The electronics power system according to claim 1, wherein the output side comprises an n-phase DC voltage output side or an AC voltage output side.

4. The electronics power system according to claim 1, further comprising a medium/high-frequency-transformer configured to provide the DC/DC isolation in the medium/high-frequency-isolated DC/DC current-to-voltage converter.

5. The electronics power system according to claim 1, wherein the medium/high-frequency-isolated DC/DC current-to-voltage converter comprises a soft switching resonant based DC/DC converter.

6. The electronics power system according to claim 5, further comprising a controller programmed to tune a switching frequency of the resonant based DC/DC converter.

7. The electronics power system according to claim 5, further comprising a controller programmed to control pulse width and switching frequency of the parallel resonant based DC/DC converter.

8. The electronics power system according to claim 5, further comprising a controller programmed to interleave at least one of inputs, outputs, and both inputs and outputs of the plurality of substantially identical power electronic modules.

9. An electronics power system comprising:
a plurality of substantially identical power electronic modules, wherein each power electronics module comprises:
a single-phase DC/AC inverter comprising an output side; and
a medium/high-frequency-transformer isolated current-to-voltage converter comprising an input side, the medium/high-frequency-transformer isolated current-to-voltage converter driving the single-phase DC/AC inverter, wherein the plurality of substantially identical power electronic modules is stacked together in series at the input side and in parallel or series/parallel at the output side to provide a scalable output voltage.

10. The electronics power system according to claim 9, further comprising a DC current source feeding the input side.

11. The electronics power system according to claim 9, wherein the output side comprises an n-phase DC voltage output side or an AC voltage output side.

12. The electronics power system according to claim 9, wherein the medium/high-frequency-isolated DC/DC current-to-voltage converter comprises a soft switching resonant based DC/DC converter.

13. The electronics power system according to claim 12, further comprising a controller programmed to tune a switching frequency of the resonant based DC/DC converter.

14. The electronics power system according to claim 12, further comprising a controller programmed to control pulse width and switching frequency of the parallel resonant based DC/DC converter.

15. The electronics power system according to claim 12, further comprising a controller programmed to interleave at least one of inputs, outputs, and both inputs and outputs of the plurality of substantially identical power electronic modules.

16. An electronics power system comprising:
a plurality of substantially identical power electronic modules, wherein each power electronics module comprises:
a DC/AC inverter comprising an output side; and
a medium/high-frequency-isolated based DC/DC current-to-voltage converter comprising an input side, an intermediate output side, and plurality of substantially identical DC/DC current-to-voltage sub-modules with a medium/high-frequency-isolated soft switched resonant based DC/DC current-to-voltage converter, wherein each sub-module, with its own input and output sides is connected in series at the input side to form the input side of DC/DC current-to-voltage converter, and connected in parallel at the output side to form the intermediate output side of DC/DC current-to-voltage converter, wherein the intermediate output side of DC/DC converter drives the DC/AC inverter, and further wherein each intermediate output side of the DC/DC converter and its corresponding DC/AC inverter are connected back-to-back sharing a common DC-link, and further wherein the plurality of power electronic modules is stacked together in series at the input side and in parallel or series/parallel at the output side.

17. The electronics power system according to claim 16, further comprising a DC current source feeding the input side.

18. The electronics power system according to claim 16, wherein the output side comprises an n-phase DC voltage output side or an AC voltage output side.

19. The electronics power system according to claim 16, further comprising a medium/high-frequency-transformer configured to provide the DC/DC isolation in the medium/high-frequency-isolated resonant based DC/DC current-to-voltage converter.

20. The electronics power system according to claim 16, further comprising a controller programmed to tune a switching frequency of the parallel resonant based DC/DC current-to-voltage converter.

21. The electronics power system according to claim 16, further comprising a controller programmed to control pulse width and switching frequency of the parallel resonant based DC/DC current-to-voltage converter.

22. The electronics power system according to claim 16, further comprising a controller programmed to interleave sub-modules within the DC/DC converter and at least one of inputs, outputs, and both inputs and outputs of the plurality of substantially identical power electronic modules.

23. An electronics power system comprising:
a plurality of substantially identical power electronic modules, wherein each power electronic module comprises:
a single-phase DC/AC folder/un-folder inverter comprising an output side; and
a medium/high-frequency-isolated DC/DC current-to-voltage converter comprising an input side, the medium/high-frequency-isolated DC/DC current-to-voltage converter driving the single-phase DC/AC folder/un-folder inverter, wherein each DC/DC converter and its corresponding DC/AC inverter are connected back-to-back sharing a common pulsating DC-link, requiring a snubber capacitor in the DC-link, and further wherein the plurality of power electronics modules is stacked together in series at the input side and in parallel or series/parallel at the output side.

24. The electronics power system according to claim 23, further comprising a DC current source feeding the input side.

25. The electronics power system according to claim 23, wherein the output side comprises an n-phase DC voltage output side or an AC voltage output side.

26. The electronics power system according to claim 23, further comprising a medium/high-frequency-transformer configured to provide the DC/DC isolation in the medium/high-frequency-isolated DC/DC current-to-voltage converter.

27. The electronics power system according to claim 23, wherein the medium/high-frequency-isolated DC/DC current-to-voltage converter comprises a soft switching resonant based DC/DC converter.

28. The electronics power system according to claim 27, further comprising a controller programmed to tune a switching frequency of the resonant based DC/DC converter.

29. The electronics power system according to claim 27, further comprising a controller programmed to control pulse width and switching frequency of the parallel resonant based DC/DC converter.

30. The electronics power system according to claim 27, further comprising a controller programmed to interleave at least one of inputs, outputs, and both inputs and outputs of the plurality of substantially identical power electronic modules.
